(19) United States
(12) Patent Application Publication
(10) Pub. No.: US 2026/0322858 A1
(43) Pub. Date: Oct. 15, 2026

(54) SYSTEM AND METHODS FOR AUTOMATED ACCESS POLICY CONFIGURATION FOR OBJECT STORAGE BUCKETS

(71) Applicant: State Farm Mutual Automobile Insurance Company, Bloomington, IL (US)

(72) Inventors: Shweta Purohit, Bloomington, IL (US); Pratiksha Babarao Wath, Bloomington, IL (US); Omkar Salgaonkar, Dombivali West (IN); Neha Bisht, Nakatpura (IN); Balakumar Rajendran, Chennai (IN); Zahid Kumar, Bangalore (IN); A Mohammed Farooq, Coimbatore (IN); Divyashree Gundurao, Devanahalli (IN); Cason Philip Demshar, Brookhaven, GA (US); Shrestha Sen, Kolkata (IN); Bojanki Mowlika, Visakhapatnam (IN); Jeffrey Marzloff, Lawrenceville, GA (US)

(73) Assignee: State Farm Mutual Automobile Insurance Company, Bloomington, IL (US)

(21) Appl. No.: 19/176,351

(22) Filed: Apr. 11, 2025

(51) Int. Cl. H04L 9/40

(52) U.S. Cl. CPC H04L 63/20; H04L 63/083; H04L 63/10; H04L 63/123

(57) ABSTRACT

Systems and methods for managing and provisioning secure access to object storage buckets are disclosed. The computer-implemented method may include, such as by one or more processors, transceivers, and/or sensors: (1) receiving a request from a user device to modify a policy associated with an object storage bucket; (2) authenticating the request based upon security protocols; (3) validating the authenticated request to confirm a presence of one or more fields; (4) retrieving the policy associated with the object storage bucket from a cloud storage service; (5) modifying the policy based upon (i) an action type specified in the request and/or (ii) attributes of the policy; (6) generating encryption keys corresponding to a requesting user for access to the object storage bucket; and/or (7) applying the modified policy and the encryption keys to the object storage bucket. The method stores both original and modified policies for robust auditing and efficient troubleshooting.

### TECHNICAL FIELD

This present disclosure relates generally to the field of access control mechanisms for cloud-based object storage systems. In particular, the present disclosure relates to the automated retrieval, analysis, and modification of access policies to manage and secure permissions for object storage buckets.

### BACKGROUND

Managing access to object storage buckets may present significant technical challenges due to the complexity of configuring and updating access policies, while also ensuring security, compliance, and efficiency. Traditional methods rely on manual policy management, which may involve manually creating, modifying, and validating policies. Such processes may often result in excessive wait times for users requesting access, as administrators may review and approve each request. Such delays may hinder productivity and degrade the user experience, especially in dynamic environments where timely access to data is critical. Additionally, such a manual approach may be error-prone and may increase the risk of misconfigurations, such as granting excessive permissions or failing to remove outdated and unauthorized roles, which may lead to security vulnerabilities and operational inefficiencies.

Furthermore, ensuring that the access policies are consistently aligned with regulatory compliance standards may be challenging when the access policies are inconsistently updated, leading to potential non-compliance or operational inefficiencies. For example, manual policy updates may inadvertently overlook the removal of stale or high-risk roles, leaving the system exposed to potential breaches. Such a manual approach may lack robust mechanisms for identifying and removing outdated or high-risk roles, which may accumulate over time, creating unnecessary security liabilities. The lack of automation may also result in the user facing fragmented workflows, with limited transparency into the status of the user's access request. This disjointed process may reduce operational efficiency and create a poor user experience. Addressing these challenges may involve a streamlined, automated approach that may dynamically manage access policies, minimize wait times, and improve overall system security.

### SUMMARY

The present embodiments may relate, inter alia, to dynamic access policy configuration and enforcement systems for object storage buckets, such as those discussed above and elsewhere herein. Specifically, the present computer systems and computer-implemented methods may solve technical challenges by automating the management of access policies for object storage buckets, including dynamic policy retrieval, validation, modification, and enforcement. The computer systems and computer-implemented methods may provide secure and efficient access control through features, such as token-based authentication, role verification, and compliance with predefined security protocols, while leveraging encryption keys and maintaining audit logs to enhance security and traceability.

In one aspect, a computer-implemented method for managing and provisioning secure access to one or more object storage buckets may be provided. The computer-implemented method may be implemented via one or more local or remote processors, servers, transceivers, memory units, mobile devices, voice bots or chatbots, ChatGPT bots, InstructGPT bots, Codex bots, Google Bard bots, and/or other electronic or electrical components, which may be in wired or wireless communication with one another. In one instance, the computer-implemented method may be performed by one or more local or remote processors of a computing system in communication with one or more local or remote data sources.

The computer-implemented method may include, via one or more processors, transceivers, sensors, and/or other components: (1) receiving, by one or more processors, a request from a user device to modify a policy associated with at least one object storage bucket; (2) authenticating, by the one or more processors, the request based upon one or more security protocols; (3) validating, by the one or more processors, the authenticated request to confirm a presence of one or more fields; (4) in response to the validating, retrieving, by the one or more processors, the policy associated with the at least one object storage bucket from a cloud storage service; (5) modifying, by the one or more processors, the policy based upon one or more of (i) an action type specified in the request and/or (ii) one or more attributes of the policy; (6) generating, by the one or more processors, one or more encryption keys corresponding to a requesting user for access to the at least one object storage bucket; and/or (7) applying, by the one or more processors, the modified policy and the one or more encryption keys to the at least one object storage bucket. The method may include additional, less, or alternate functionality, including that discussed elsewhere herein.

In another aspect, a computer system for managing and provisioning secure access to one or more object storage buckets may be provided. The computer system may be implemented via one or more local or remote processors, servers, transceivers, memory units, mobile devices, voice bots or chatbots, ChatGPT bots, InstructGPT bots, Codex bots, Google Bard bots, and/or other electronic or electrical components, which may be in wired or wireless communication with one another. In one instance, the computer system may be performed by one or more local or remote processors of a computing system in communication with one or more local or remote data sources, and at least one non-transitory computer readable medium storing instructions which, when executed by the one or more processors, cause the one or more processors to perform certain operations. The computer system may include, via one or more processors, non-transitory computer readable medium, transceivers, sensors, and/or other components to perform operations that may include: (1) receiving a request from a user device to modify a policy associated with at least one object storage bucket; (2) authenticating the request based upon one or more security protocols; (3) validating the authenticated request to confirm a presence of one or more fields; (4) in response to the validating, retrieving the policy associated with the at least one object storage bucket from a cloud storage service; (5) modifying the policy based upon one or more of (i) an action type specified in the request and/or (ii) one or more attributes of the policy; (6) generating one or more encryption keys corresponding to a requesting user for access to the at least one object storage bucket; and/or (7) applying the modified policy and the one or more encryption keys to the at least one object storage bucket. The system may include additional, less, or alternate functionality, including that discussed elsewhere herein.

In yet another aspect, a non-transitory computer readable medium for managing and provisioning secure access to one or more object storage buckets may be provided. The non-transitory computer readable medium may be implemented via one or more local or remote processors, servers, transceivers, memory units, mobile devices, voice bots or chatbots, ChatGPT bots, InstructGPT bots, Codex bots, Google Bard bots, and/or other electronic or electrical components, which may be in wired or wireless communication with one another. In one instance, the non-transitory computer readable medium may be performed by one or more local or remote processors of a computing system in communication with one or more local or remote data sources, and at least one non-transitory computer readable medium storing instructions which, when executed by the one or more processors, cause the one or more processors to perform certain operations. The non-transitory computer readable medium may include, via one or more processors, transceivers, sensors, and/or other components: (1) receiving a request from a user device to modify a policy associated with at least one object storage bucket; (2) authenticating the request based upon one or more security protocols; (3) validating the authenticated request to confirm a presence of one or more fields; (4) in response to the validating, retrieving the policy associated with the at least one object storage bucket from a cloud storage service; (5) modifying the policy based upon one or more of (i) an action type specified in the request and/or (ii) one or more attributes of the policy; (6) generating one or more encryption keys corresponding to a requesting user for access to the at least one object storage bucket; and/or (7) applying the modified policy and the one or more encryption keys to the at least one object storage bucket. The operations may include additional, less, or alternate functionality, including that discussed elsewhere herein.

### BRIEF DESCRIPTION OF THE DRAWINGS

The figures described below depict various aspects of the system and methods disclosed herein. It should be understood that each figure depicts an embodiment of a particular aspect of the disclosed system and methods, and that each of the figures is intended to accord with a possible embodiment thereof. Further, wherever possible, the following description refers to the reference numerals included in the following figures, in which features depicted in multiple figures are designated with consistent reference numerals.

FIG. 1 is a diagram showing an exemplary computer system 100 that may manage user access to object storage buckets by validating a request, modifying access policies, and applying security controls, according to certain aspects of the disclosure.

FIG. 2 is an exemplary flowchart of a computer-implemented or computer-based process for managing and provisioning secure access to one or more object storage buckets, according to certain aspects of the disclosure.

FIG. 3 is an exemplary flowchart of a computer-implemented or computer-based process for validating, backing up, modifying, and enforcing an access policy to facilitate access to one or more object storage buckets, according to certain aspects of the disclosure.

FIG. 4 is an exemplary flowchart of a computer-implemented or computer-based process for managing and modifying access control policies for one or more object storage buckets, according to certain aspects of the disclosure.

FIG. 5 illustrates an implementation of an exemplary computer system that executes one or more techniques presented herein.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION

The present embodiments may relate, inter alia, to computer systems and computer-implemented methods that may solve technical challenges by automating an access policy configuration, dynamically managing permissions, integrating secure encryption key generation, and streamlining the provisioning of access to object storage buckets.

The process of configuring and managing access policies for object storage buckets may be fraught with complexities, primarily due to the reliance on multi-step manual workflows. For example, accessing data often involves several stakeholders, necessitating the approval and interventions from numerous team members (e.g., the IT team, the data security team, etc.). This manual approach is not only time-consuming, but may also be prone to human error, creating bottlenecks that may impede the scalability and agility of the object storage buckets.

The dynamic nature of access requirements for object storage buckets may also present technical challenges. Access policies, designed to provide fine-grained control, may need regular updates to grant access, revoke access, or to reflect changes in organizational needs. For example, the roles defined within access policies may become obsolete, unauthorized, or even pose security vulnerabilities over time. Manually identifying and addressing these outdated roles may need periodic reviews, which may be susceptible to oversight and may lead to misconfigurations and inconsistencies. Ensuring that the permissions remain accurate, secure, and aligned with governance standards may become a cumbersome task, especially in environments with frequent access changes or complex compliance requirements.

In addition, object storage buckets may rely on encryption keys to securely encrypt and decrypt data. However, the process of synchronizing encryption key generation with updates to access policies may introduce complexity. For instance, the need for secure real-time generation and application of these keys may exacerbate the already resource-intensive nature of manual policy configuration. A lack of synchronization between policy updates and encryption processes may create inefficiencies, and may increase the risk of data breaches and access failures.

As a result, there is a need for advanced data-driven models, methods, and tools for automating access policy configuration, synchronizing encryption management, and optimizing secure access provisioning for object storage systems.

### Exemplary Computer System

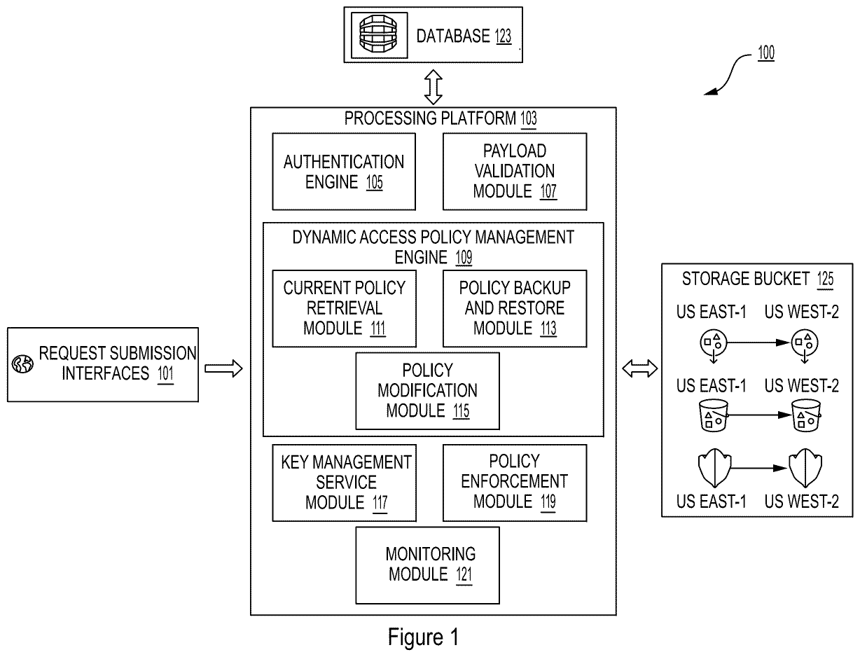

To address technical challenges such as the above, computing system 100 of FIG. 1 may improve the state of conventional technologies by automating the process of object storage access control through an integrated policy management framework. The computing system 100 may enhance security and operational efficiency by programmatically validating user requests, retrieving and modifying access policies, and dynamically generating encryption keys for secure access. The computing system 100 may further improve upon traditional methods by eliminating manual intervention in policy configuration, backup, and enforcement, thereby ensuring compliance with organizational and regulatory standards. Additionally, the computing system 100 may leverage scalable databases for seamless policy backup and restoration, while providing robust auditing and monitoring capabilities to ensure transparency and accountability.

FIG. 1 is a diagram showing an exemplary computer system 100 that may manage user access to object storage buckets by validating a request, modifying access policies, and applying security controls. FIG. 1 includes the computing system 100 that includes a request submission interface 101, a processing platform 103, a database 123, and a storage bucket 125. It should be understood that other implementations of computing system 100 may omit one or more of the foregoing components and/or may include additional components, as the case may be.

In one instance, the request submission interface 101 may facilitate the initiation and management of API requests for access policy configuration, as well as utilizing tools or other API testing and interaction frameworks. The request submission interface 101 may allow users to submit requests that include details, such as the object storage bucket name, region, and the desired action type (e.g., add, delete, or modify). In one example, a tool may include a web-based interactive documentation system that dynamically adapts to the API schema, enabling users to test API endpoints with minimal setup. For one example, a tool may serve as a robust API testing environment that allows users to define and send HTTP requests with customizable headers and payloads. These tools may ensure that the requests are correctly formatted and validated before the backend system processes the requests, resulting in reducing the likelihood of errors and enhancing the overall reliability of the workflow. Moreover, the request submission interface 101 may support authentication mechanisms, such as encryption keys or tokens, to secure the submission process and restrict access to authorized users.

In one instance, the processing platform 103 may include a platform with multiple interconnected components. The processing platform 103 may include one or more servers, intelligent networking devices, computing devices, components, and corresponding software for providing a unified environment. The unified environment may handle user requests, policy retrieval, policy validation, policy modification, and policy enforcement for facilitating the secure and efficient access to object storage buckets. For example, the processing platform 103 may authenticate a user, analyze a request payload, retrieve and modify the access policy, and apply appropriate security measures. In one example, a payload may refer to the actual data or information transmitted as part of a request or message. A request payload may include structured data, often in JSON or XML format, that may specify the parameters or details of the operation being requested, such as access type, resource identified, user credentials, or additional metadata. Analyzing the request payload may include verifying the presence and correctness of mandatory fields, such as access type, resource name, and/or an identity and access management (IAM) principal, and ensuring their values conform to expected formats and syntax. In one example, an access policy may be a set of rules and permissions associated with an object storage bucket, defining which entities (e.g., users or systems) may access the object storage bucket. The processing platform 103 may incorporate advanced mechanisms, such as key management and encryption to safeguard sensitive data, during the process. By leveraging technologies like DynamoDB for policy storage and backup, the processing platform 103 may facilitate the tracking and restoration of previous policy states when needed. Furthermore, the processing platform 103 may audit and monitor some or all system activities, such as the real-time logging and monitoring of policy modification, access requests, and/or security events to allow users to track actions taken on access policies, as well as identify any anomalies or unauthorized activities. Such an end-to-end automation may significantly reduce the complexity and risk associated with manual policy management, thereby providing a streamlined and scalable solution for managing object storage bucket access.

In one instance, the processing platform 103 may include an authentication engine 105, a payload validation module 107, a dynamic access policy management engine 109, a key management service module 117, a policy enforcement module 119, monitoring module 121, or any combination thereof. As used herein, terms such as “component” or “module” generally encompass hardware and/or software, e.g., that a processor or the like used to implement associated functionality. It is contemplated that the functions of these components are combined in one or more components or performed by other components of equivalent functionality.

In one instance, the authentication engine 105 may verify the identity and credentials of the user(s) requesting access to a system or resource, such as one or more object storage buckets (e.g., storage bucket 125). The authentication engine 105 may decode a token passed in the request to verify its integrity and validity, in order to extract essential authentication and authorization details. In one example, the token may be a secure, encoded string used to represent and transmit authentication and authorization information between a user and a system, ensuring access is granted only to verified and permitted entities. The authentication engine 105 may check whether the token grants proper access permissions to perform the requested operations. To ensure further validation, the authentication engine 105 may create a client associated with the request and compare it with the details encoded in the token. If all these checks are successfully satisfied, the system 100 proceeds to process the request. Otherwise, the authentication engine 105 may respond, in real-time, with an invalid access error, thereby denying the operation. In another instance, the authentication engine 105 may implement one or more advanced security mechanisms, including multi-factor authentication (MFA), to ensure that only authorized user(s) may proceed with the request. For example, upon receiving a request, the authentication engine 105 may validate the provided credentials, such as a username, a password, and a one-time passcode (OTPs), against a secure database or directory service. Additionally, the authentication engine 105 may monitor authentication attempts for suspicious activities, such as repeated login failures or access from unrecognized devices, and may trigger alerts of block access as needed. By ensuring robust and scalable authentication, the authentication engine 105 may enhance system security.

In one instance, the payload validation module 107 may ensure that incoming requests include the necessary information to proceed with the requested operation. It may check if the needed fields are present in the payload, including an access type, a resource name, IAM principal, a request number, and the user executing the request. If all needed fields are present, the payload validation module 107 may further check that none of the field values are empty, ensuring that valid data is provided. The payload validation module 107 may also validate the syntax of the critical fields, such as the resource name and IAM principal, ensuring that the fields follow the proper format and adhere to any system constraints. If all such checks are successful, the system 100 may proceed to the next steps of the process. However, if any of the validation criteria are not met, the payload validation module 107 may generate an appropriate error response indicating which part of the request is invalid, and the system may send the response back to the user, preventing further processing of invalid requests. This process may ensure that only properly structured and complete requests are allowed to proceed, resulting in maintaining system integrity and security.

In one instance, the dynamic access policy management engine 109 may automate the management of access policies for object storage buckets (e.g., storage bucket 125). The dynamic access policy management engine 109 may dynamically evaluate and adjust an access policy based on one or more user requests, ensuring compliance with security, regulatory, and organizational standards. The dynamic access policy management engine 109 may continuously monitor access requests and may modify policies in response to changing operational needs, such as updates in access permissions, roles, or access conditions. By automating the policy modification process, the dynamic access policy management engine 109 may enhance operational efficiency, reduce human error, and maintain a high level of security and compliance. In one instance, the dynamic access policy management engine 109 may include a current policy retrieval module 111, a policy backup and restore module 113, a policy modification module 115, or any combination thereof.

In one instance, the current policy retrieval module 111 may retrieve the existing access policy of the object storage bucket from one or more data sources (e.g., database 123) and prepare the retrieved access policy for processing. For example, the current policy retrieval module 111 may check whether the specified object storage bucket exists in the system 100 by validating the bucket's name and ensuring it corresponds to an existing resource. If the object storage bucket does not exist, an error response may be returned. On the other hand, if the object storage bucket exists, the current policy retrieval module 111 may verify that the requesting user has appropriate permissions to access the requested policy. If the permissions are not sufficient, an error response may be issued. Successful verification may cause the current policy retrieval module 111 to retrieve the current access policy associated with the object storage bucket in a JSON format (a standard format used by storage buckets to define access policies). The system may pass the retrieved policy to a backup module (e.g., database 123), where it is securely stored for future reference. Additionally, the current policy retrieval module 111 may convert the JSON policy into Python classes that represent key components, such as the object storage bucket, policy statements, principals, and any associated encryption keys (KSM) to facilitate an easier manipulation and analysis during the subsequent policy modification steps. Converting to Python may allow the system 100 to validate, query, and modify policies efficiently using methods encapsulated within Python classes, such as adding or removing statements. Python objects may also facilitate seamless integration across modules, simplify debugging and logging, and leverage Python libraries optimized for object handling.

In one instance, the policy backup and restore module 113 may ensure the integrity and recoverability of access policies for object storage buckets. The policy backup and restore module 113 may maintain a reliable history of policy changes and enable the efficient restoration when needed, supporting robust access management practice. In one instance, the backup process may begin by generating a structured payload for storing the current policy in database 123. This payload may include fields such as a unique transaction ID to trace the operation, a request number to associate it with the specific user request, the JSON representation of the policy, and the resource name of the object storage bucket. By organizing this data, the policy backup and restore module 113 may ensure that each policy backup is uniquely identifiable and easily retrievable for subsequent operation. Once the payload is generated, the policy may be securely stored in a designated table of the database 123. For the restoration process, the policy backup and restore module 113 may accept the bucket name and the corresponding transaction ID as inputs. The policy backup and restore module 113 may query database 123 to locate the specific policy associated with the given transaction. Upon successfully retrieving the policy, the policy backup and restore module 113 may prepare the policy for application to the object storage bucket, replacing the current policy.

In one instance, the policy modification module 115 may dynamically update the access policies associated with object storage buckets. Upon receiving a validated request, the policy modification module 115 may identify the action type specified in the payload, which may include an add request or a delete request. For add requests, the policy modification module 115 may append new policy statements to the existing policy, as defined in the payload. These new statements may include the access permission, resource names, and/or IAM principals needed for the operation. In one example, the IAM principals may refer to entities, such as users, groups, roles, or applications, that are authorized to interact with specified resources, enabling fine-grained access control within a system. For deletion requests, the policy modification module 115 may scan the existing policy to locate and remove any statements matching the criteria provided in the payload. This process may involve identifying specific permissions, resource names, and/or principals that may need to be revoked. If the requested deletion does not find a match, the policy modification module 115 may log an error or notify the user.

In one instance, the policy modification module 115 may process the retrieved policy to identify and delete bad or unwanted roles. These roles may include unauthorized, outdated, or security-risk entries that may compromise the security of the object storage buckets. By identifying these roles, the policy modification module 115 may proactively enhance the security of the access policy. The new policy may be programmatically applied through an automated process, ensuring a seamless implementation without needing manual intervention. Additionally, the modified policy is subjected to a systematic validation procedure to verify compliance with predefined organizational policies and regulatory requirements. Once the modifications are complete, the updated policy may replace the existing policy associated with the object storage buckets. Through the streamlined operations, the policy modification module 115 may not only update access policies, but also ensure that modifications are secure, traceable, and in compliance with governance rules.

In one instance, the key management service module 117 may generate, distribute, and manage encryption keys necessary for secure access to object storage buckets. Upon receiving a request that may need key generation, the key management service module 117 may dynamically generate keys that are securely encoded and associated with the requesting user or application, thereby ensuring that the generated key is unique and meets cryptographic security standards. This process may involve selecting an appropriate encryption algorithm and defining key properties, such as size and expiration of the encryption keys, based on organizational policies and compliance requirements. Once generated, the encryption keys may be securely distributed to authorized users or systems through encrypted channels, resulting in minimizing the risk of interception or unauthorized access. The key management service module 117 may enforce key lifecycle policies, including a periodic key rotation, revocation of compromised or obsolete keys, and the secure destruction of retired keys.

In one instance, the policy enforcement module 119 may apply the updated access policies to the designated object storage buckets. For example, once the updated policy has been validated and modified through preceding modules, the policy enforcement module 119 may directly interact with the object storage buckets to replace the existing policy with the updated policy. Before applying the updated policy, the policy enforcement module 119 may conduct a validation check to verify compliance with organizational access protocol and regulatory standards. This may involve analyzing the policy syntax, structure, and permissions to ensure there are no conflicts or unauthorized permissions. In one example, the policy enforcement module 119 may ensure that the policy size is within acceptable limits (e.g., less than 20 KB) of the storage bucket 125. For example, if the policy size exceeds 20 KB, the policy enforcement module 119 may return an error response, preventing the application of oversized policies. When the size of the policy is within acceptable limits, the policy enforcement module 119 may programmatically apply to the specified bucket (e.g., storage bucket 125) and its associated access point in a particular region (e.g., the US East region). After a successful application in the particular region, the same validated policy may be applied to the corresponding object storage bucket and access points in another region (e.g., the United States West region). Such synchronization may maintain consistent access controls across different geographic regions, ensuring unified security and compliance.

In one instance, the monitoring module 121 may track, record, and evaluate actions performed during the policy management cycle. The monitoring module 121 may maintain a detailed log of every request and action, such as a policy retrieval, a policy modification, backups of policies, and policy enforcement. These logs may include critical metadata, such as the user ID, transaction ID, timestamps, resource names, and policy changes. This information may be securely stored in a centralized logging system (e.g., database 123) to facilitate easy access for audits and reviews. The monitoring module 121 may also monitor system behavior and generate alerts for unusual or unauthorized activities, such as repeated invalid access attempts or attempts to apply policies with excessive or risky permissions. A real-time dashboard may be generated in a user device to provide users with insights into system performance, usage trends, and potential vulnerabilities. The user device may include a smart mobile communication device, a wireless communication device, a multimedia tablet, a notebook computer, a mobile device, etc. The monitoring module 121 may also support audit trails for regulatory compliance, these trails may include a detailed history of policy modifications, key generation activities, and policy applications.

In one example, database 123 may store and manage the metadata associated with object storage bucket policies, user requests, and system transactions. The database 123 may securely store information such as transaction IDs, request numbers, JSON policies, and resource names, resulting in ensuring quick retrieval and consistency. By leveraging DynamoDB or a similar scalable, low-latency database solution, the database 123 may facilitate the seamless backup, restoration, and/or auditing functionalities. The database 123 may support high availability and fault tolerance, ensuring that critical data related to access control and policy management is reliably stored and may be accessed for further processing.

### Exemplary Policy Configuration For Accessing Object Storage Buckets Flowchart

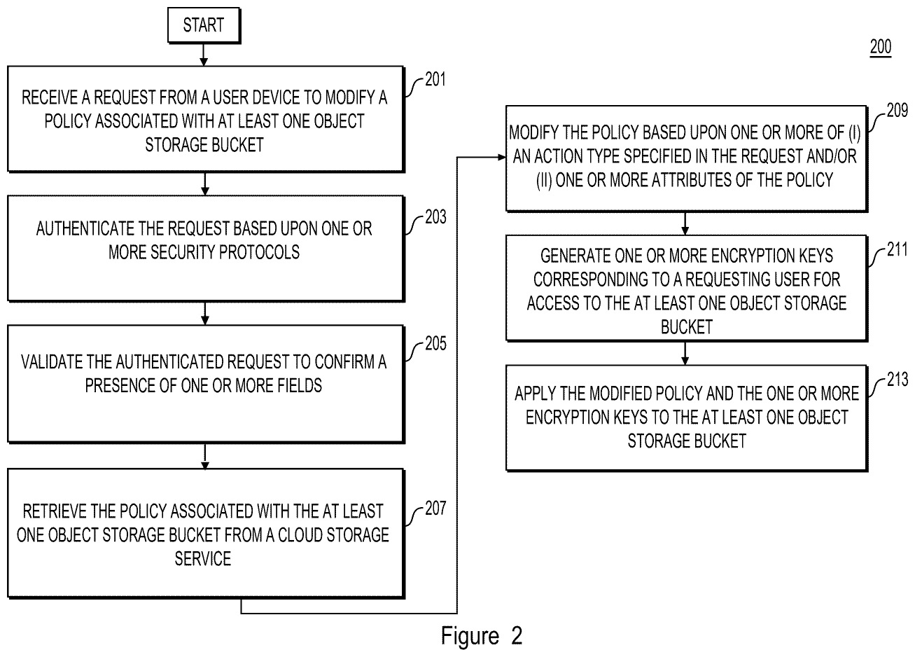

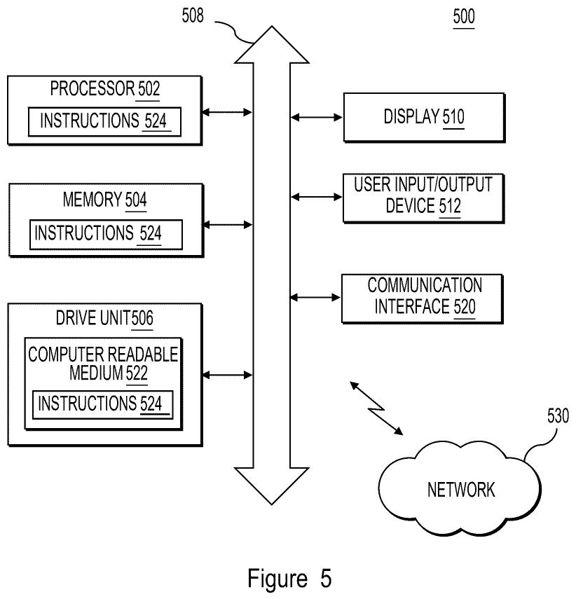

FIG. 2 is an exemplary flowchart of a computer-implemented or computer-based process for managing and provisioning secure access to one or more object storage buckets. In one instance, the processing platform 103 and/or any of the modules 105-121 may perform one or more portions of the process 200 and are implemented using, for instance, a chip set including a processor (e.g., processor 502) and a memory (e.g., memory 504) as shown in FIG. 5. As such, the processing platform 103 and/or any of modules 105-121 may be configured to facilitate accomplishing various parts of the process 200, as well as accomplishing embodiments of other processes described herein in conjunction with other components of the computing system 100. Although the process 200 is illustrated and described as a sequence of actions, operations, and/or functionality, it is contemplated that various embodiments of the process 200 may be performed in any order or combination and need not include all of the illustrated actions, operations, and/or functionality.

In block 201, the processing platform 103 may receive a request from a user device to modify a policy associated with at least one object storage bucket. The request may include an access request, where the user may seek to update the permission for a specific object storage bucket (e.g., storage bucket 125). The user device may include a computing device, a mobile device, or an automated system that may transmit the request through a secure interface. The policy may include a set of rules that may define who can access the object storage bucket and what actions they can perform, such as reading, writing, or deleting data.

In block 203, the processing platform 103 may authenticate the request based upon one or more security protocol(s) to ensure that only authorized users can modify the policy. The security protocols may include tokens (e.g., JSON web tokens), API keys, and/or multi-factor authentication. In one instance, to authenticate the request, the processing platform 103 may decode a token included in the request and may extract authentication metadata. The processing platform 103 may verify that the authentication metadata includes permissions for executing the request. The processing platform 103 may generate a client identifier (e.g., a unique value derived from user credentials or session information that represents the user) associated with the request for comparison with the token. The processing platform 103 may determine whether the client identifier and the token satisfy the validation criteria to either (i) authorize the request to proceed to the next step, or (ii) return an invalid access response to the user device.

In block 205, the processing platform 103 may validate the authenticated request to confirm the presence of one or more fields. In one instance, the processing platform 103 may check that the request includes the required fields (e.g., an access type, a resource name, an identity and access management (IAM) principal, a request number, and/or a user executing the request). The processing platform 103 may then verify that the values in these required fields are valid (e.g., correct, complete, proper format, etc.). The processing platform 103 may also validate the syntax of the required fields (e.g., resource name and/or IAM principal) for compliance with system-defined formats. The processing platform 103 may determine whether the required fields are present, valid, and/or formatted to either (i) authorize the request to proceed to the next step, or (ii) return an invalid access response to the user device.

In block 207, the processing platform 103 may retrieve the policy associated with the object storage bucket from a cloud storage service (e.g., database 123). The policy may be retrieved in a JSON format. The processing platform 103 may determine permissions corresponding to the policy and modifications required for completing the request. In one instance, the processing platform 103 may parse the policy to extract permission-related data. The processing platform 103 may compare the permission-related data against access levels specified in the request to identify the modifications to the policy. The processing platform 103 may store a backup of the policy in a secure data store (e.g., database 123) before modifying the policy. The processing platform 103 may convert the policy into a structured format (e.g., Python format) using one or more classes that represent one or more attributes of the object storage bucket.

In block 209, the processing platform 103 may modify the policy based upon one or more of (i) an action type specified in the request, and/or (ii) one or more attributes of the policy (e.g., access level, roles, allowed actions, etc.). In one example, the action type may include an add action for appending new permission statements to the policy upon determining that the requested access exceeds existing permissions. In one example, the action type may include a delete action for removing permissions upon the determination that the requested access needs a revocation of the existing permissions. In one instance, the processing platform 103 may process the policy to identify roles, such as outdated roles, unauthorized roles, and/or non-compliant roles. The processing platform 103 may remove these roles from the policy and may store the modified policy in the secure data store.

In one instance, the processing platform 103 may perform a validation check of the modified policy, wherein the validation check may include comparing the modified policy against the configuration data of the object storage bucket. The processing platform 103 may detect one or more conflicts during the validation check and adjust the modified policy for granting valid and non-conflicting permissions to the requesting user.

In one instance, the processing platform 103 may monitor the actions performed during the provisioning of secure access to the object storage bucket, and may store the actions in the database 123 for compliance and review.

In block 211, the processing platform 103 may generate encryption keys corresponding to the requesting user for accessing the object storage bucket. The encryption keys may be dynamically generated to encrypt the access credentials for authenticating the requesting user to access the object storage bucket.

In block 213, the processing platform 103 may apply the modified policy and encryption keys to the object storage bucket. In one instance, the modified policy may control who can access the object storage bucket, what actions may be performed, and under what conditions, while the encryption keys may ensure that sensitive data is encryption both in transit and at rest.

### Exemplary Policy Management Flowchart

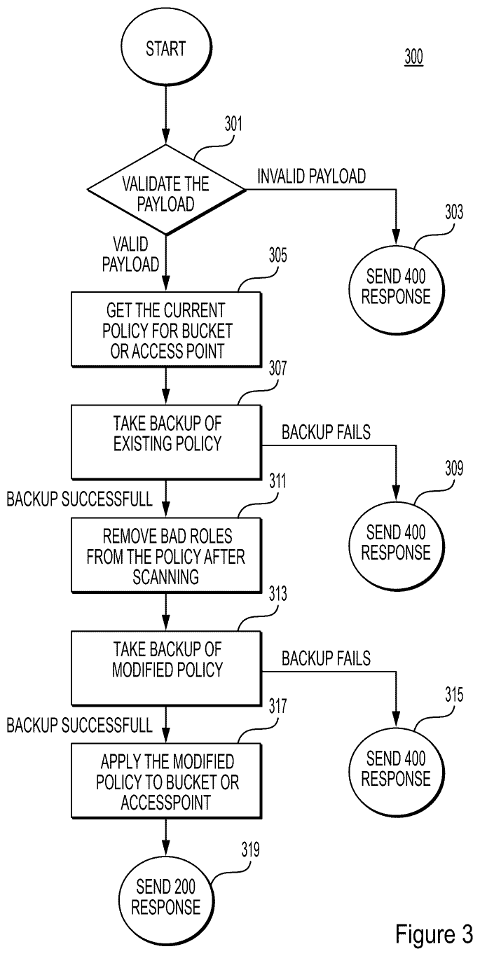

FIG. 3 is an exemplary flowchart of a computer-implemented or computer-based process for validating, backing up, modifying, and enforcing access policies to facilitate access to object storage buckets. In one instance, the processing platform 103 and/or any of the modules 105-121 may perform one or more portions of the process 300 and are implemented using, for instance, a chip set including a processor (e.g., processor 502) and a memory (e.g., memory 504) as shown in FIG. 5. As such, the processing platform 103 and/or any of modules 105-121 may be configured to facilitate accomplishing various parts of the process 300, as well as accomplishing embodiments of other processes described herein in conjunction with other components of the computing system 100. Although the process 300 is illustrated and described as a sequence of actions, operations, and/or functionality, it is contemplated that various embodiments of the process 300 may be performed in any order or combination and need not include all of the illustrated actions, operations, and/or functionality.

In block 301, the processing platform 103 may validate the payload submitted by the user, which is an essential part of the access request. The processing platform 103 may check that the needed fields, such as an access type, a resource name (e.g., bucket or access point), an IAM principal (identifying the user or service making the request), a request number, and/or identity of the entity requesting the action (e.g., executed by) are present. In addition to checking for the presence of these fields, the processing platform 103 may ensure that the required fields follow the correct syntax (e.g., valid resource names, properly formatted IAM principals) and that no field values are left empty.

In block 303, the processing platform 103 may determine that the payload failed at least one of the checks, and may transmit a 400 bad request response to the user, resulting in halting further execution.

In block 305, the processing platform 103 may determine that the payload is valid, and may retrieve the current policy for the specified object storage bucket or access point, preparing it for subsequent execution. This process may ensure that only valid and properly structured requests are processed.

In block 307, the processing platform 103 may retrieve the current policy associated with the specified object storage bucket or access point. The retrieved policy is then backed up in a database (e.g., DynamoDB). This backup may ensure that the original policy is preserved for audits and rollback purposes. Such backup may be needed for tracking the history of policy changes, which may facilitate the maintenance of data integrity and compliance.

In block 309, the processing platform 103 may determine a failure in backing up the policy to the database, and may transmit a 400 bad request response to the user that indicates that the backup operation did not succeed. The processing platform 103 may halt further processing to prevent inconsistent states.

In block 311, the processing platform 103 may determine the backup was successful, and analyzes the policy to identify roles that are deemed problematic, e.g., unauthorized, outdated, or security-risk roles. The identified roles may be flagged and removed from the policy to mitigate potential security vulnerabilities.

In block 313, the processing platform 103 may back up the modified policy in the database to facilitate traceability by preserving a historical version of the modified policy and may help in restoring the policy to a previous state, if needed.

In block 315, the processing platform 103 may determine that the backup was unsuccessful, and may transmit a 400 bad request response to the user that indicates that the backup operation did not succeed. This process may prevent the system from proceeding with potentially invalid or incomplete configurations, as well as ensure that no erroneous changes are applied to the access policy.

In block 317, the processing platform 103 may determine the backup was successful, and may programmatically apply the modified policy to the specified storage bucket or access point.

In block 319, after successfully applying the modified policy, the processing platform 103 may transmit a 200 response to confirm that the operation was completed without errors.

By following this structured process, the processing platform 103 may ensure that the updated policies are not only securely stored and traceable, but also that they are applied consistently and reliably. The error handling mechanism (e.g., 400 responses) may prevent partial or incorrect configurations from being implemented.

### Exemplary Access Policy Configuration Flowchart

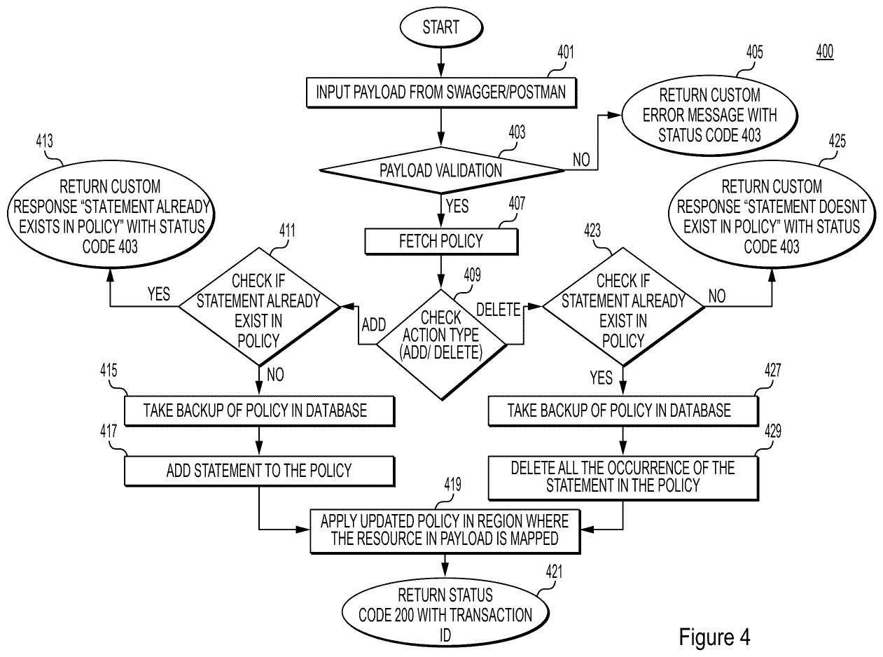

FIG. 4 is an exemplary flowchart of a computer-implemented or computer-based process for managing and modifying access control policies for object storage buckets. In one instance, the processing platform 103 and/or any of the modules 105-121 may perform one or more portions of the process 400 and are implemented using, for instance, a chip set including a processor (e.g., processor 502) and a memory (e.g., memory 504) as shown in FIG. 5. As such, the processing platform 103 and/or any of modules 105-121 may be configured to facilitate accomplishing various parts of the process 400, as well as accomplishing embodiments of other processes described herein in conjunction with other components of the computing system 100. Although the process 400 is illustrated and described as a sequence of actions, operations, and/or functionality, it is contemplated that various embodiments of the process 400 may be performed in any order or combination and need not include all of the illustrated actions, operations, and/or functionality.

In block 401, the processing platform 103 may receive a payload submitted by a user through interfaces (e.g., request submission interfaces), such as Swagger UI or Postman. The payload may serve as the input to the system, encapsulating some or all parameters needed to process the access policy update request. The payload may include a JSON object that comprises information about the requested action, such as the resource name, an access type (e.g., read, write, or delete), a user identity (e.g., IAM principal), and/or action type (e.g., add or delete).

In block 403, the processing platform 103 may validate the payload by checking that the required fields, such as an access type, a resource name (e.g., bucket or access point), an IAM principal (identifying the user or service making the request), a request number, identity of the entity requesting the action (e.g., executed by) are present. In addition, the processing platform 103 may ensure that the required fields follow the correct syntax (e.g., valid resource names, properly formatted IAM principals) and that no field values are left empty.

In block 405, the processing platform 103 may determine the payload failed at least one of the checks and may transmit a custom error message with status code 403 to the user device. The response may explicitly indicate the error to facilitate the correction.

In block 407, the processing platform 103 may determine that the payload is valid, and may retrieve the current policy for the specified object storage bucket or access point from a data source. In one instance, the policy is typically stored in the database 123 (e.g., DynamoDB), which may maintain mappings between resources (e.g., object storage buckets) and their associated access policies. The processing platform 103 may query the database using the resource name and user-specific identifiers provided in the payload. The retrieved JSON policy may be parsed into structured objects (e.g., Python classes for buckets, policy statements, and principals) for further processing.

In block 409, the processing platform 103 may process the action type, specified in the payload, to determine whether the request pertains to adding or deleting policy statements. Based on the action type, the processing platform 103 may determine whether to initiate the logic for adding or removing policy statements.

In block 411, the processing platform 103 may determine that the request pertains to adding policy statements. The processing platform 103 may check if the statement already exists in the policy by comparing the incoming statement with one or more existing policy statements using identifiers (e.g., action name, resource, principal).

In block 413, the processing platform 103 may determine that the statement to be added already exists in the current policy, whereupon a custom error response (e.g., “statement already exists in policy”) may be transmitted to the user device with a status code (e.g., status code 403), preventing redundant entries.

In block 415, the processing platform 103 may determine that the statement to be added does not exist in the current policy. The processing platform 103 may back up the existing policy in the database for traceability and rollback purposes.

In block 417, the processing platform 103 may programmatically append the new statement to the policy's JSON structure. In one instance, JSON manipulation libraries (e.g., Python's JSON module) may be used to append new statements.

In block 419, the processing platform 103 may apply the updated policy to the region where the resource is mapped. This may ensure that the new policy rules take effect immediately, as well as define the permissions and constraints for users or roles interacting with the bucket. If the updated policy grants permissions for specific actions (e.g., reading, writing, or deleting objects) requested by the user, access is authorized. In one instance, the processing platform 103 may perform policy synchronization across regions, and the updated policy may be replicated to other regions'buckets associated with the same resource.

In block 421, the processing platform 103 may transmit a response (e.g., 200 (OK) response) including a unique transaction ID upon successful policy application.

In block 423, the processing platform 103 may determine that the request pertains to deleting policy statements. The processing platform 103 may check if a specified statement for deletion exists in the policy by comparing the incoming statement with existing policy statements using identifiers (e.g., action name, resource, principal).

In block 425, the processing platform 103 may determine the statement to be deleted does not exist in the current policy, whereupon a custom error response “statement does not exist in policy” may be transmitted to the user device with status code 403.

In block 427, the processing platform 103 may determine that the statement to be deleted exists in the current policy. The processing platform 103 may back up the existing policy in the database for traceability and rollback purposes.

In block 429, the processing platform 103 may programmatically remove all occurrences of the specified statement(s) from the policy's JSON structure. In one instance, libraries like JSON or utility functions may be used for filtering and/or deleting specific keys or values.

In block 419, the processing platform 103 may apply the updated policy to the region where the resource is mapped. This may ensure that the new policy rules take effect immediately and define the permissions and constraints for users or roles interacting with the bucket.

In block 421, the processing platform 103 may transmit a response (e.g., 200 (OK) response) that may include a unique transaction ID upon successful policy application.

In such a manner, the process 400 may manage access policies for object storage buckets, ensuring that all operations are securely validated, efficiently executed, and seamlessly integrated.

### Exemplary Computing Environment

In general, any process or operation discussed in this disclosure is understood to be computer-implementable, such as the processes illustrated in FIG. 2 and may be performed by one or more processors of a computer system as described herein. A process or process action or operation performed by one or more processors may also be referred to as an operation. The one or more processors may be configured to perform such processes by having access to instructions (e.g., software or computer-readable code) that, when executed by one or more processors, cause the one or more processors to perform the processes. The instructions may be stored in a memory of the computer system. A processor may be a central processing unit (CPU), a graphics processing unit (GPU), or any suitable type of processing unit.

A computer system, such as a system or device implementing a process or operation in the examples above, may include one or more computing devices. One or more processors of a computer system may be included in a single computing device or distributed among a plurality of computing devices. One or more processors of a computer system may be connected to a data storage device. A memory of the computer system may include the respective memory of each computing device of the plurality of computing devices.

FIG. 5 illustrates an implementation of a computer system that may execute techniques presented herein. The computer system 500 can include a set of instructions that can be executed to cause the computer system 500 to perform any one or more of the methods or computer based functions disclosed herein. The computer system 500 may operate as a standalone device or may be connected, e.g., using a network, to other computer systems or peripheral devices.

Unless specifically stated otherwise, as apparent from the following discussions, it is appreciated that throughout the specification, discussions utilizing terms such as “processing,” “computing,” “calculating,” “determining”, “analyzing” or the like, refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory. A “computer,” a “computing machine,” a “computing platform,” a “computing device,” or a “server” may include one or more processors.

In a networked deployment, the computer system 500 may operate in the capacity of a server or as a client user computer in a server-client user network environment, or as a peer computer system in a peer-to-peer (or distributed) network environment. The computer system 500 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular implementation, the computer system 500 may be implemented using electronic devices that provide voice, video, or data communication. Further, while the computer system 500 is illustrated as a single system, the term “system” shall also be taken to include any collection of systems or sub-systems that individually or jointly execute a set, or multiple sets, of instructions to perform one or more computer functions.

As illustrated in FIG. 5, the computer system 500 may include a processor 502, e.g., a central processing unit (CPU), a graphics processing unit (GPU), or both. The processor 502 may be a component in a variety of systems. For example, the processor 502 may be part of a standard personal computer or a workstation. The processor 502 may be one or more processors, digital signal processors, application specific integrated circuits, field programmable gate arrays, servers, networks, digital circuits, analog circuits, combinations thereof, or other now known or later developed devices for analyzing and processing data. The processor 502 may implement a software program, such as code generated manually (i.e., programmed).

The computer system 500 may include a memory 504 that can communicate via bus 508. The memory 504 may be a main memory, a static memory, or a dynamic memory. The memory 504 may include, but is not limited to, computer readable storage media such as various types of volatile and non-volatile storage media, including but not limited to, random access memory, read-only memory, programmable read-only memory, electrically programmable read-only memory, electrically erasable read-only memory, flash memory, magnetic tape or disk, optical media and the like. In one implementation, the memory 504 includes a cache or random-access memory for the processor 502. In alternative implementations, the memory 504 is separate from the processor 502, such as a cache memory of a processor, the system memory, or other memory. The memory 504 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 504 is operable to store instructions executable by the processor 502. The functions, acts or tasks illustrated in the figures or described herein may be performed by the processor 502 executing the instructions stored in the memory 504. The functions, acts, or tasks are independent of the particular type of instruction set, storage media, processor or processing strategy and may be performed by software, hardware, integrated circuits, firmware, micro-code and the like, operating alone or in combination. Likewise, processing strategies may include multiprocessing, multitasking, parallel processing, and the like.

As shown, the computer system 500 may further include a display 510, such as a liquid crystal display (LCD), an organic light emitting diode (OLED), a flat panel display, a solid-state display, a cathode ray tube (CRT), a projector, a printer or other now known or later developed display device for outputting determined information. The display 510 may act as an interface for the user to see the functioning of the processor 502, or specifically as an interface with the software stored in the memory 504 or in the drive unit 506.

Additionally or alternatively, the computer system 500 may include an input/output device 512 configured to allow a user to interact with any of the components of the computer system 500. The input/output device 512 may be a number pad, a keyboard, or a cursor control device, such as a mouse, or a joystick, touch screen display, remote control, or any other device operative to interact with the computer system 500.

The computer system 500 may also or alternatively include drive unit 506 implemented as a disk or optical drive. The drive unit 506 may include a computer-readable medium 522 in which one or more sets of instructions 524, e.g., software, can be embedded. Further, instructions 524 may embody one or more of the methods or logic as described herein. The instructions 524 may reside completely or partially within the memory 504 and/or within the processor 502 during execution by the computer system 500. The memory 504 and the processor 502 also may include computer-readable media as discussed above.

In some systems, computer-readable medium 522 includes the set of instructions 524 or receives and executes the set of instructions 524 responsive to a propagated signal so that a device connected to network 530 can communicate voice, video, audio, images, or any other data over the network 530. Further, the set of instructions 524 may be transmitted or received over the network 530 via communication port or interface 520, and/or using bus 508. The communication port or interface 520 may be a part of the processor 502 or may be a separate component. The communication port or interface 520 may be created in software or may be a physical connection in hardware. The communication port or interface 520 may be configured to connect with a network 530, external media, the display 510, or any other components in computer system 500, or combinations thereof. The connection with the network 530 may be a physical connection, such as a wired Ethernet connection or may be established wirelessly as discussed below. Likewise, the additional connections with other components of the computer system 500 may be physical connections or may be established wirelessly. The network 530 may alternatively be directly connected to the bus 508.

While the computer-readable medium 522 is shown to be a single medium, the term “computer-readable medium” may include a single medium or multiple media, such as a centralized or distributed database, and/or associated caches and servers that store one or more sets of instructions. The term “computer-readable medium” may also include any medium that is capable of storing, encoding, or carrying a set of instructions for execution by a processor or that causes a computer system to perform any one or more of the methods or operations disclosed herein. The computer-readable medium 522 may be non-transitory, and may be tangible.

The computer-readable medium 522 can include a solid-state memory such as a memory card or other package that houses one or more non-volatile read-only memories. The computer-readable medium 522 can be a random-access memory or other volatile re-writable memory. Additionally or alternatively, the computer-readable medium 522 can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative implementation, dedicated hardware implementations, such as application specific integrated circuits, programmable logic arrays and other hardware devices, can be constructed to implement one or more of the methods described herein. Applications that may include the apparatus and systems of various implementations can broadly include a variety of electronic and computer systems. One or more implementations described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

Computer system 500 may be connected to network 530. The network 530 may define one or more networks including wired or wireless networks. The wireless network may be a cellular telephone network, an 802.10, 802.16, 802.20, or WiMAX network. Further, such networks may include a public network, such as the Internet, a private network, such as an intranet, or combinations thereof, and may utilize a variety of networking protocols now available or later developed including, but not limited to TCP/IP based networking protocols. The network 530 may include wide area networks (WAN), such as the Internet, local area networks (LAN), campus area networks, metropolitan area networks, a direct connection such as through a Universal Serial Bus (USB) port, or any other networks that may allow for data communication.

The network 530 may be configured to couple one computing device to another computing device to enable communication of data between the devices. The network 530 may generally be enabled to employ any form of machine-readable media for communicating information from one device to another. The network 530 may include communication methods by which information may travel between computing devices.

The network 530 may be divided into sub-networks. The sub-networks may allow access to all of the other components connected thereto or the sub-networks may restrict access between the components. The network 530 may be regarded as a public or private network connection and may include, for example, a virtual private network or an encryption or other security mechanism employed over the public Internet, or the like.

### Exemplary Embodiments

A computer-implemented method for managing and provisioning secure access to one or more object storage buckets may be provided. The computer-implemented method may be performed by one or more local or remote processors of a computing system in communication with one or more local or remote data sources. The computer-implemented method may include:
(1) receiving, by one or more processors, a request from a user device to modify a policy associated with at least one object storage bucket; (2) authenticating, by the one or more processors, the request based upon one or more security protocols; (3) validating, by the one or more processors, the authenticated request to confirm a presence of one or more fields; (4) in response to the validating, retrieving, by the one or more processors, the policy associated with the at least one object storage bucket from a cloud storage service; (5) modifying, by the one or more processors, the policy based upon one or more of (i) an action type specified in the request and/or (ii) one or more attributes of the policy; (6) generating, by the one or more processors, one or more encryption keys corresponding to a requesting user for access to the at least one object storage bucket; and/or (7) applying, by the one or more processors, the modified policy and the one or more encryption keys to the at least one object storage bucket.

In some embodiments, the voice bots or chatbots may be configured to utilize AI and/or ML techniques, such as for input or output devices. For instance, a voice bot or chatbot may be a ChatGPT chatbot, an InstructGPT bot, a Codex bot, or a Google Bard bot. The voice bot or chatbot may employ supervised or unsupervised ML techniques, which may be followed by, and/or used in conjunction with, reinforced or reinforcement learning techniques. The voice bot or chatbot may employ the techniques utilized for ChatGPT, InstructGPT bot, Codex bot, or Google Bard bot.

In some embodiments, authenticating the request may include (i) decoding, by the one or more processors, a token included in the request; (ii) extracting, by the one or more processors, authentication metadata from the decoded token; (iii) verifying, by the one or more processors, that the authentication metadata includes one or more permissions for executing the request; (iv) generating, by the one or more processors, a client identifier associated with the request for comparison with the token; and/or (v) determining, by the one or more processors, whether the client identifier and the token satisfy one or more validation criteria to either (a) authorize the request to proceed to next step or (b) return an invalid access response to the user device.

In certain embodiments, validating the authenticated request may include (i) checking, by the one or more processors, that the request includes the one or more fields, wherein the one or more fields include an access type, a resource name, an identity and access management (IAM) principal, a request number, or a user executing the request; (ii) verifying, by the one or more processors, that one or more values in the one or more fields are valid; (iii) validating, by the one or more processors, a syntax of the resource name and/or IAM principal for compliance with one or more system-defined formats; and/or (iv) determining, by the one or more processors, whether the one or more fields are present, valid, and formatted to either (a) authorize the request to proceed to next step or (b) return an invalid access response to the user device.

Additionally or alternatively, the policy is retrieved in a JSON format.

In certain aspects, modifying the policy may include determining, by the one or more processors, one or more permissions corresponding to the policy and one or more modifications for completing the request.

In some embodiments, determining the one or more permissions and identifying the one or more modifications to complete the request may include (i) parsing, by the one or more processors, the policy to extract permission-related data; (ii) comparing, by the one or more processors, the permission-related data against access levels specified in the request to identify the one or more modifications to the policy; (iii) storing, by the one or more processors, a backup of the policy in a secure data store prior to modifying the policy; and/or (iv) converting, by the one or more processors, the policy into a structured format using one or more classes that represent one or more attributes of the at least one object storage bucket.

In certain embodiments, the action type may include one or more of (i) an add action for appending one or more new permission statements to the policy upon determining that a requested access exceeds one or more existing permissions, and/or (ii) a delete action for removing one or more permissions upon determining that the requested access requests a revocation of the one or more existing permissions.

In various embodiments, modifying the policy based upon the one or more attributes of the policy may include (i) processing, by the one or more processors, the policy to identify one or more roles, wherein the one or more roles include an outdated role, an unauthorized role, or a non-compliant role; (ii) removing, by the one or more processors, the one or more roles from the policy; and/or (iii) modifying, by the one or more processors, the policy based upon the action type.

In certain aspects, modifying the policy may include storing, by the one or more processors, the modified policy in a secure data store.

Additionally or alternatively the one or more encryption keys are dynamically generated to encrypt one or more access credentials for authenticating the requesting user to access the at least one object storage bucket.

In some embodiments, authenticating the request may include (i) decoding, by the one or more processors, modifying the policy may include (i) monitoring, by the one or more processors, one or more actions performed during provisioning of the secure access to the at least one object storage bucket; and/or (ii) storing, by the one or more processors, the one or more actions for compliance and review.

In certain embodiments, modifying the policy may include (i) performing, by the one or more processors, a validation check of the modified policy, wherein the validation check includes comparing the modified policy against configuration data of the at least one object storage bucket; (ii) detecting, by the one or more processors, one or more conflicts during the validation check; and/or (iii) adjusting, by the one or more processors, the modified policy for granting one or more valid and non-conflicting permissions to the requesting user.

A computer system for managing and provisioning secure access to one or more object storage buckets may be provided. The computer system may include one or more processors of a computing system, and at least one non-transitory computer readable medium storing instructions which, when executed by the one or more processors, cause the one or more processors to perform operations. The computer system may perform operations including (1) receiving a request from a user device to modify a policy associated with at least one object storage bucket; (2) authenticating the request based upon one or more security protocols; (3) validating the authenticated request to confirm a presence of one or more fields; (4) in response to the validating, retrieving the policy associated with the at least one object storage bucket from a cloud storage service; (5) modifying the policy based upon one or more of (i) an action type specified in the request and/or (ii) one or more attributes of the policy; (6) generating one or more encryption keys corresponding to a requesting user for access to the at least one object storage bucket; and/or (7) applying the modified policy and the one or more encryption keys to the at least one object storage bucket.

In some embodiments, authenticating the request may include (i) decoding a token included in the request; (ii) extracting authentication metadata from the decoded token; (iii) verifying that the authentication metadata includes one or more permissions for executing the request; (iv) generating a client identifier associated with the request for comparison with the token; and/or (v) determining whether the client identifier and the token satisfy one or more validation criteria to either (a) authorize the request to proceed to next step or (b) return an invalid access response to the user device.

In certain embodiments, validating the authenticated request may include (i) checking that the request includes the one or more fields, wherein the one or more fields include an access type, a resource name, an identity and access management (IAM) principal, a request number, or a user executing the request; (ii) verifying that one or more values in the one or more fields are valid; (iii) validating a syntax of the resource name and/or IAM principal for compliance with one or more system-defined formats; and/or (iv) determining whether the one or more fields are present, valid, and formatted to either (a) authorize the request to proceed to next step or (b) return an invalid access response to the user device.

Additionally or alternatively, the policy is retrieved in a JSON format.

In certain aspects, modifying the policy may include determining one or more permissions corresponding to the policy and one or more modifications for completing the request.

In some embodiments, determining the one or more permissions and identifying the one or more modifications to complete the request may include (i) parsing the policy to extract permission-related data; (ii) comparing the permission-related data against access levels specified in the request to identify the one or more modifications to the policy; (iii) storing a backup of the policy in a secure data store prior to modifying the policy; and/or (iv) converting the policy into a structured format using one or more classes that represent one or more attributes of the at least one object storage bucket.

A non-transitory computer readable medium for managing and provisioning secure access to one or more object storage buckets may be provided. The non-transitory computer readable medium may store instructions which, when executed by one or more processors, cause the one or more processors to perform operations. The one or more processors may perform operations including (1) receiving a request from a user device to modify a policy associated with at least one object storage bucket; (2) authenticating the request based upon one or more security protocols; (3) validating the authenticated request to confirm a presence of one or more fields; (4) in response to the validating, retrieving the policy associated with the at least one object storage bucket from a cloud storage service; (5) modifying the policy based upon one or more of (i) an action type specified in the request and/or (ii) one or more attributes of the policy; (6) generating one or more encryption keys corresponding to a requesting user for access to the at least one object storage bucket; and/or (7) applying the modified policy and the one or more encryption keys to the at least one object storage bucket.

In some embodiments, authenticating the request may include (i) decoding a token included in the request; (ii) extracting authentication metadata from the decoded token; (iii) verifying that the authentication metadata includes one or more permissions for executing the request; (iv) generating a client identifier associated with the request for comparison with the token; and/or (v) determining whether the client identifier and the token satisfy one or more validation criteria to either (a) authorize the request to proceed to next step or (b) return an invalid access response to the user device.

### Additional Considerations

Although the present specification describes components and functions that may be implemented in particular implementations with reference to particular standards and protocols, the disclosure is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

It will be understood that the actions, operations, and/or functionality of computer-implemented methods discussed are performed in one embodiment by an appropriate processor (or processors) of a processing (i.e., computer) system executing instructions (computer-readable code) stored in storage. It will also be understood that the disclosure is not limited to any particular implementation or programming technique and that the disclosure may be implemented using any appropriate techniques for implementing the functionality described herein. The disclosure is not limited to any particular programming language or operating system.

Although the text herein sets forth a detailed description of numerous different embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

It should also be understood that, unless a term is expressly defined in this patent using the sentence “As used herein, the term ‘_______’ is hereby defined to mean . . . ” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning.

Finally, unless a claim element is defined by expressly reciting the word “means” and a function without the recital of any structure, it is not intended that the scope of any claim element be interpreted based upon the application of 35 U.S.C. § 112(f).

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in exemplary configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (code embodied on a non-transitory, tangible machine-readable medium) or hardware. In hardware, the routines, etc., are tangible units capable of performing certain operations and may be configured or arranged in a certain manner. In exemplary embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC) to perform certain operations). A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of exemplary methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some exemplary embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of geographic locations.

Unless specifically stated otherwise, discussions herein using words such as processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment may be included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

Upon reading this disclosure, those of skill in the art will appreciate still additional alternative structural and functional designs for the approaches described herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The particular features, structures, or characteristics of any specific embodiment may be combined in any suitable manner and in any suitable combination with one or more other embodiments, including the use of selected features without corresponding use of other features. In addition, many modifications may be made to adapt a particular application, situation or material to the essential scope and spirit of the present invention. It is to be understood that other variations and modifications of the embodiments of the present invention described and illustrated herein are possible in light of the teachings herein and are to be considered part of the spirit and scope of the present invention.

While the preferred embodiments of the invention have been described, it should be understood that the invention is not so limited and modifications may be made without departing from the invention. The scope of the invention is defined by the appended claims, and all devices that come within the meaning of the claims, either literally or by equivalence, are intended to be embraced therein.

It is therefore intended that the foregoing detailed description be regarded as illustrative rather than limiting, and that it be understood that it is the following claims, including all equivalents, that are intended to define the spirit and scope of this invention.

What is claimed is:

1. A computer-implemented method for managing and provisioning secure access to one or more object storage buckets, comprising:
receiving, by one or more processors, a request from a user device to modify a policy associated with at least one object storage bucket;
authenticating, by the one or more processors, the request based upon one or more security protocols;
validating, by the one or more processors, the authenticated request to confirm a presence of one or more fields;
in response to the validating, retrieving, by the one or more processors, the policy associated with the at least one object storage bucket from a cloud storage service;
modifying, by the one or more processors, the policy based upon one or more of (i) an action type specified in the request and/or (ii) one or more attributes of the policy;
generating, by the one or more processors, one or more encryption keys corresponding to a requesting user for access to the at least one object storage bucket; and
applying, by the one or more processors, the modified policy and the one or more encryption keys to the at least one object storage bucket.

2. The computer-implemented method of claim 1, wherein authenticating the request further comprises:
decoding, by the one or more processors, a token included in the request;
extracting, by the one or more processors, authentication metadata from the decoded token;
verifying, by the one or more processors, that the authentication metadata includes one or more permissions for executing the request;
generating, by the one or more processors, a client identifier associated with the request for comparison with the token; and
determining, by the one or more processors, whether the client identifier and the token satisfy one or more validation criteria to either (i) authorize the request to proceed to next step or (ii) return an invalid access response to the user device.

3. The computer-implemented method of claim 1, the computer-implemented method further comprising:
checking, by the one or more processors, that the request includes the one or more fields, wherein the one or more fields include an access type, a resource name, an identity and access management (IAM) principal, a request number, or a user executing the request;
verifying, by the one or more processors, that one or more values in the one or more fields are valid;
validating, by the one or more processors, a syntax of the resource name and/or IAM principal for compliance with one or more system-defined formats; and
determining, by the one or more processors, whether the one or more fields are present, valid, and formatted to either (i) authorize the request to proceed to next step or (ii) return an invalid access response to the user device.

4. The computer-implemented method of claim 1, wherein the policy is retrieved in a JSON format.

5. The computer-implemented method of claim 1, the computer-implemented method further comprising:
determining, by the one or more processors, one or more permissions corresponding to the policy and one or more modifications for completing the request.

6. The computer-implemented method of claim 5, wherein determining the one or more permissions and identifying the one or more modifications to complete the request further comprises:
parsing, by the one or more processors, the policy to extract permission-related data;
comparing, by the one or more processors, the permission-related data against access levels specified in the request to identify the one or more modifications to the policy;
storing, by the one or more processors, a backup of the policy in a secure data store prior to modifying the policy; and
converting, by the one or more processors, the policy into a structured format using one or more classes that represent one or more attributes of the at least one object storage bucket.

7. The computer-implemented method of claim 1, wherein the action type includes one or more of (i) an add action for appending one or more new permission statements to the policy upon determining that a requested access exceeds one or more existing permissions, or (ii) a delete action for removing one or more permissions upon determining that the requested access requests a revocation of the one or more existing permissions.

8. The computer-implemented method of claim 1, wherein modifying the policy based upon the one or more attributes of the policy further comprises:
processing, by the one or more processors, the policy to identify one or more roles, wherein the one or more roles include an outdated role, an unauthorized role, or a non-compliant role;
removing, by the one or more processors, the one or more roles from the policy; and
modifying, by the one or more processors, the policy based upon the action type.

9. The computer-implemented method of claim 8, the computer-implemented method further comprising:
storing, by the one or more processors, the modified policy in a secure data store.

10. The computer-implemented method of claim 1, wherein the one or more encryption keys are dynamically generated to encrypt one or more access credentials for authenticating the requesting user to access the at least one object storage bucket.

11. The computer-implemented method of claim 1, the computer-implemented method further comprising:
monitoring, by the one or more processors, one or more actions performed during provisioning of the secure access to the at least one object storage bucket; and
storing, by the one or more processors, the one or more actions for compliance and review.

12. The computer-implemented method of claim 1, wherein modifying the policy further comprises:
performing, by the one or more processors, a validation check of the modified policy, wherein the validation check includes comparing the modified policy against configuration data of the at least one object storage bucket;
detecting, by the one or more processors, one or more conflicts during the validation check; and
adjusting, by the one or more processors, the modified policy for granting one or more valid and non-conflicting permissions to the requesting user.

13. A computer system for managing and provisioning secure access to one or more object storage buckets, comprising:
one or more processors of a computing system; and
at least one non-transitory computer readable medium storing instructions which, when executed by the one or more processors, cause the one or more processors to perform operations comprising:
receiving a request from a user device to modify a policy associated with at least one object storage bucket;
authenticating the request based upon one or more security protocols;
validating the authenticated request to confirm a presence of one or more fields;
in response to the validating, retrieving the policy associated with the at least one object storage bucket from a cloud storage service;
modifying the policy based upon one or more of (i) an action type specified in the request and/or (ii) one or more attributes of the policy;
generating one or more encryption keys corresponding to a requesting user for access to the at least one object storage bucket; and
applying the modified policy and the one or more encryption keys to the at least one object storage bucket.

14. The computer system of claim 13, wherein authenticating the request further comprises:
decoding a token included in the request;
extracting authentication metadata from the decoded token;
verifying that the authentication metadata includes one or more permissions for executing the request;
generating a client identifier associated with the request for comparison with the token; and
determining whether the client identifier and the token satisfy one or more validation criteria to either (i) authorize the request to proceed to next step or (ii) return an invalid access response to the user device.

15. The computer system of claim 13, further comprising:
checking that the request includes the one or more fields, wherein the one or more fields include an access type, a resource name, an identity and access management (IAM) principal, a request number, or a user executing the request;
verifying that one or more values in the one or more fields are valid;
validating a syntax of the resource name and/or IAM principal for compliance with one or more system-defined formats; and
determining whether the one or more fields are present, valid, and formatted to either (i) authorize the request to proceed to next step or (ii) return an invalid access response to the user device.

16. The computer system of claim 13, wherein the policy is retrieved in a JSON format.

17. The computer system of claim 13, further comprising:
determining one or more permissions corresponding to the policy and one or more modifications for completing the request.

18. The computer system of claim 17, wherein determining the one or more permissions and identifying the one or more modifications to complete the request further comprises:
parsing the policy to extract permission-related data;
comparing the permission-related data against access levels specified in the request to identify the one or more modifications to the policy;
storing a backup of the policy in a secure data store prior to modifying the policy; and
converting the policy into a structured format using one or more classes that represent one or more attributes of the at least one object storage bucket.

19. A non-transitory computer readable medium for managing and provisioning secure access to one or more object storage buckets, the non-transitory computer readable medium storing instructions which, when executed by one or more processors of a computing system, cause the one or more processors to perform operations comprising:
receiving a request from a user device to modify a policy associated with at least one object storage bucket;
authenticating the request based upon one or more security protocols;
validating the authenticated request to confirm a presence of one or more fields;
in response to the validating, retrieving the policy associated with the at least one object storage bucket from a cloud storage service;
modifying the policy based upon one or more of (i) an action type specified in the request and/or (ii) one or more attributes of the policy;
generating one or more encryption keys corresponding to a requesting user for access to the at least one object storage bucket; and
applying the modified policy and the one or more encryption keys to the at least one object storage bucket.

20. The non-transitory computer readable medium of claim 19, wherein authenticating the request further comprises:
decoding a token included in the request;
extracting authentication metadata from the decoded token;
verifying that the authentication metadata includes one or more permissions for executing the request;
generating a client identifier associated with the request for comparison with the token; and
determining whether the client identifier and the token satisfy one or more validation criteria to either (i) authorize the request to proceed to next step or (ii) return an invalid access response to the user device.
